(19) United States
(12) Patent Application Publication
(10) Pub. No.: US 2016/0051918 A1
(43) Pub. Date: Feb. 25, 2016

(54) Filter Medium, Particularly an Air Filter Medium and Filter Element, Particularly an Air Filter Element, Having a Filter Medium

(71) Applicant: Mann+Hummel GMBH, Ludwigsburg (DE)

(72) Inventors: Stefan Walz, Freiberg (DE); Mario Keller, Winnenden (DE); Steffen Pfannkuch, Stuttgart (DE); Michael Heim, Korntal-Muenchingen (DE); Ivanka Poljak, Stuttgart (DE); Jens Neumann, Stuttgart (DE); Alexander Kilian, Stuttgart (DE); Gelase Mbadinga Mouanda, Laval (FR)

(21) Appl. No.: 14/922,063

(22) Filed: Oct. 23, 2015

Related U.S. Application Data
(63) Continuation of application No. PCT/EP2014/057631, filed on Apr. 15, 2014.

(30) Foreign Application Priority Data
Apr. 23, 2013 (DE) 10 2013 006 952.1
May 17, 2013 (DE) 10 2013 008 391.5

(51) Int. Cl. B01D 39/16; B01D 46/52; B01D 39/18

(52) U.S. Cl. CPC B01D 39/1623; B01D 39/18; B01D 46/521

(57) ABSTRACT

A filter medium is provided with a first filter layer and a second filter layer that is arranged downstream of the first filter layer in a flow-through direction of the filter medium and has nanofibers. The first filter layer has a first filter layer section and a second filter layer section, wherein the second filter layer section is arranged downstream of the first filter layer section in the flow-through direction of the filter medium. The first filter layer section has a first packing density of fibers and the second filter layer section has a second packing density of fibers deviating from the first packing density of fibers.

### CROSS-REFERENCE TO RELATED APPLICATIONS

This application is a continuation application of international application No. PCT/EP2014/057631 having an international filing date of 15 Apr. 2014 and designating the United States, the international application claiming a priority date of 23 Apr. 2013, based on prior filed German patent application No. 10 2013 006 952.1, and further claiming a priority date of 17 May 2013, based on prior filed German patent application No. 10 201 3 008 391.5, the entire contents of the aforesaid international applications and the aforesaid two German patent applications being incorporated herein by reference.

### BACKGROUND OF THE INVENTION

The invention concerns the technical field of processing and filtering fluids and particularly air, for example, the filtration of liquid such as, for example, oil or of air for internal combustion engines. In particular, the invention concerns a filter medium such as, for example, an air filter medium and a filter element with such a filter medium.

Air filters are used, for example, in the air intake of internal combustion engines in order to remove contaminants and dirt particles from the air supplied for combustion so that only purified air is supplied to the combustion process in the internal combustion engine.

An air filter comprises an inflow opening for unpurified raw air and an outflow opening for the filtered clean air as well as an air filter medium wherein the air filter medium fulfills the actual filtering function. The air intake of the internal combustion engine is realized via the outflow opening of the air filter wherein the internal combustion engine sucks in the required air or air quantity. The air filter medium is comprised, for example, of a filter paper through which the air to be filtered flows when the internal combustion engine sucks in air so that the dirt particles are removed or separated from the air passing through in the air filter medium.

The air filter medium can be folded (folded filter) or can comprise a plurality of filter chambers (fluted filter) in order to enlarge the surface area of the filter so that also the service life of an air filter element is extended because a larger filter surface area can absorb more dirt particles before the pressure loss at the air filter medium that is caused by the deposited dust increases such that the performance of the internal combustion engine decreases.

EP 2 060 311 A1 describes an air filter medium for a vacuum cleaner bag with at least one layer of dry-laid nonwoven which comprises a polymeric endless fiber.

### SUMMARY OF THE INVENTION

It is an object of the invention to provide a filter medium, particularly an air filter medium, and a filter, which are characterized by an increased dirt particle storage capacity.

According to the invention, a filter medium, particularly an air filter medium, is provided that comprises a first filter layer and a second filter layer. The first filter layer comprises a first filter layer section and a second filter layer section wherein the second filter layer section is arranged downstream of the first filter layer section in a flow-through direction of the filter medium. The first filter layer section comprises a first packing density of fibers or a first packing density value and the second filter layer section comprises a second packing density of fibers that differs from the first packing density of fibers or a second packing density value that differs from the first packing density value. The second filter layer in the flow-through direction is arranged downstream of the first filter layer and comprises nanofibers and, in an embodiment, can be a nanofiber filter layer.

The packing density and a packing density value are in particular the average packing density or the average packing density value of a filter layer section or a filter layer.

The flow-through direction extends transversely or orthogonally to the first and second filter layers and thus also transversely or orthogonally to the first and second filter layer sections of the first filter layer. Accordingly, the air flow to be filtered flows through all filter layers of the air filter medium and also all filter layer sections of each filter layer.

Due to the filter layer sections with different packing density that are arranged behind each other, it can be achieved that the filter medium stores dirt particles in its volume and, as a function of the size of the dirt particles, separates them sequentially, namely comparatively large dirt particles first, i.e., by the first filter layer section with a high porosity value, and the finer dirt particles by the second filter layer section with a lower porosity value which is positioned deeper in the flow-through direction.

The second filter layer constitutes additionally a terminal filter function by means of a nanofiber filter layer. With it, smallest dirt particles can be filtered out of the fluid flow to be filtered. In particular in comparison to the first filter layer and primarily to the second filter layer section, the second filter layer comprises pores of a smaller size so that finer dirt particles can be filtered out of the fluid to be filtered.

A filter layer section is a plane of a filter layer of the filter medium wherein the filter layer section extends transversely to the flow-through direction through at least a portion of the filter layer and of the filter medium. When a fluid flow is guided through the filter medium, the fluid flow passes in flow-through direction one or several filter layer sections one after another.

A filter layer section is thus a depth section of a filter layer in the direction of the flow-through direction with pre-determinable depth and can be, for example, in the range of magnitude of several μm, for example, between 10 μm and 100 μm, or of several mm, for example, 1 mm.

A fluid flow can be a gas or liquid flow that is guided through the filter element for the purpose of filtration or separation of contaminants or dirt particles. It should be noted that in the following an air filter is described partially; however the explanations regarding the configuration of the air filter may concern also a filter medium in general.

In the following, first the terms that are used in this document will be defined.

The packing density is a measure for the proportion of the filter fibers per depth of a filter layer section, i.e., the packing density is to be understood as packing density of fibers or filter fibers per surface unit or volume unit. The packing density can be determined for each filter layer and for each filter layer section, for example, by means of a polished section or cut section of the air filter medium embedded in synthetic resin. Such a polished section is subjected to image recording and the surface area of the polished section is evaluated in that a ratio is determined of the proportion of the surface area of the polished section that is covered with fibers relative to the total surface area of a filter layer section or of the proportion of the surface area of the polished section that is not covered with fibers relative to the total surface area of a filter layer section.

The determination of the packing density can be realized in the recorded image by evaluation of the image points where a fiber can be seen and those image points that indicate an interstice. In case of a fixed or known total number of image points in the filter layer section, it is thus possible to determine the packing density in that a ratio is formed of the number of image points that show a filter fiber relative to the total number of image points in the filter layer section. Alternatively, the number of image points that show an interstice can be subtracted from the total number of image points in order to provide, for example, a check value in this way. As a function of whether the interstices or the fibers on the cut section can be distinguished and evaluated better, the corresponding image points can be counted.

The thus determined packing density is an average packing density of the evaluated filter layer section. The smaller such a filter layer section is selected, i.e., the smaller the depth of a filter layer section in the direction of the flow-through direction, the smaller the deviations of the packing density at the edges of the filter layer section from the determined average value.

The packing density can also be determined by means of a three-dimensional computer tomography image. In analogy to the image points of a recorded image, in case of a three-dimensional image there are spatial points whose number and size depend on the technical parameters of the recording device. Determination of the packing density of a three-dimensional image by means of spatial points is carried out in analogy to the method with image points. A ratio of the spatial points comprising an interstice and of the spatial points comprising a filter fiber relative to the total number of spatial points, respectively, can be formed in order to determine the packing density in this way.

Packing density jump concerns a sudden change of the packing density across the material depth of the air filter medium, i.e., two adjoining filter layer sections have a different packing density at the transition between the adjoining filter layer sections. Such a packing density jump can function in particular as a usually undesirable dirt barrier and can lead to clogging of an air filter medium before the latter has reached its maximum dirt particle storage capacity in that the dirt particles occupy and clog a depth section of the air filter medium around the packing density jump.

In this context, in particular a percental change of the packing density between the outflow surface of a filter layer and the inflow surface of a filter layer adjoining in the flow-through direction can be decisive for prevention of dirt barriers. The packing density gradient can serve as a measure for the change of the packing density across the material thickness of a filter layer in the flow-through direction. The packing density increases either through a decreasing number of fiber interstices or through a decreasing size of fiber interstices in a depth section of a filter layer, i.e., in a filter layer section.

A gradient in the context of this document is used as a value which indicates the rate of change of a parameter. For example, the packing density gradient indicates by which rate the packing density of an air filter medium with increasing material depth or material thickness changes in the direction of the flow-through direction of the air filter medium. The fiber diameter gradient indicates by which rate the fiber diameter of the fibers in an air filter medium changes with increasing material depth or material thickness in the direction of the flow-through direction of the air filter medium.

The porosity of a filter layer is a measure for the number and the size of the interstices between the filter fibers of the filter layer. The porosity can indicate, for example, which resistance a fluid flow such as, for example, an air flow penetrating a filter layer encounters. In this context, a filter layer is open at the inflow surface and at the outflow surface so that a fluid flow can penetrate at the inflow surface into the material and at the outflow surface can exit from the material. The porosity can be considered the ratio of cavity volume to total volume. With increasing value of the porosity, the proportion of the cavity volume relative to the total volume becomes greater.

The pore volume can be determined as a percental proportion of the total volume of a sample. This requires using the weight per surface area and the material thickness of the sample. The corresponding equation is as follows:

ε=100−(Fg/(ρ×10×d))

wherein
ε: pore volume as a percental proportion of the total volume in percent;
Fg: weight per surface area of the sample in g/m²;
ρ: density of the employed filter material, i.e., for example, of the fibers; for pure wood pulp paper without addition of synthetic fibers and/or glass fibers, it is 1.51 g/m³; in samples comprised of various fibers an average density can be used which is based on the respective individual density as well as the proportion of the respective fiber in the sample, i.e., for the determination of the pore volume of mixed papers the specific density and the quantity proportion of the respective components must be known;
d: thickness of the sample in mm.

The porosity of an air filter medium, of a filter layer, or of a filter layer section can be defined in particular individually by the specification of the pore volume.

In this context, a measurement can be carried out on an individual filter layer. However, a filter layer that is divided into individual depth sections can be subjected to the measurement. The finer the depth sections whose porosity is to be determined, the more precise a course of porosity across the material depth of a filter layer can be specified.

A porosity jump is a sudden change of the porosity at adjoining surfaces of neighboring filter layers or filter layer sections.

The packing density can be considered the counterpart of the porosity. In this context, the porosity is in particular determined and specified with the aid of fiber interstices or pores of the air filter medium while the packing density can be determined and specified in particular with the aid of the existing fibers. Packing density and porosity can thus be considered as complementary parameters.

The determination of the air permeability of an air filter medium can be carried out according to DIN EN ISO 9237 which requires a testing surface area of 20 cm² and a differential pressure of 200 Pa. In this context, samples are to be taken at ten different locations of the air filter medium to be tested and to be tested. The samples have in general a diameter of 56 mm and are of a circular shape. Should the filter medium be too narrow in order to provide such a sample size, the diameter of a sample can be 42 mm or even 25 mm. The result is specified as an average value and as mean variation with the unit of measure of l/m²s.

An air filter medium or an individual filter layer is comprised of a plurality of fibers. A fiber is characterized inter alia by its fiber diameter or generally by its fiber cross-section or the surface area of the cross-section. The fiber diameter or fiber cross-section is specified as an average fiber diameter or fiber cross-section, wherein for these values a specification by means of logarithmic normal distribution is used.

An air filter medium can be comprised of one or several filter layers which are each comprised, in turn, of one or of several fibers. The filter action of an air filter medium is caused in this context in that an air flow flows through the filter layers and the dirt particles contained in the air flow are retained in the interstices of the fibers or adhere to the fibers and are separated from the air flow.

A fiber diameter gradient indicates by which measure the diameter of the fibers of an air filter medium changes across the material depth of a filter layer or of a filter layer section. This applies in an analog manner also to a fiber cross-section gradient.

The fiber diameter gradient between the first filter layer and the second filter layer should be as minimal as possible, i.e., the fiber diameter of the fibers in the second filter layer section deviates as little as possible from the fiber diameter of the fibers in the second filter layer.

Nanofibers are to be understood in the context of this specification as fibers with a fiber diameter between approximately 50 nm and approximately 500 nm, preferably between approximately 100 nm and 300 nm.

A nanofiber layer or nanofiber filter layer is a filter layer which comprises nanofibers or is comprised partially or completely of nanofibers.

The terms meltblown, spunbond, wet-laid, and dry-laid layer manufacture, carded nonwoven, filament spunbond nonwoven, and cross-laid nonwoven are defined in “Vliesstoffe: Rohstoffe, Herstellung, Anwendung, Eigenschaften, Prüfung” (translated title reads “Nonwovens: Raw Materials, Manufacture, Use, Properties, Testing”), 2nd edition, 2012, Weinheim, Germany; ISBN: 978-3-527-31519-2.

A filter layer comprises a thickness in the flow-through direction and a fluid flow to be filtered passes through it transversely or orthogonally to an extension plane of the filter layer. A filter layer can be manufactured in a continuous manufacturing process and can comprise fibers of a same manufacturing process, wherein the fibers may have a fiber diameter or fiber cross-section deviating from each other. Denier: unit of measure for the fineness of a fiber, weight per length, this is based on 1 den=1 gram/9,000 m.

Tex: unit of measure for the fineness of a fiber, weight per length, 1 tex=1 gram/1,000 m, 1 dtex (decitex)=0.1 tex=1 gram/10,000 m.

The term “steady” is used in the context of this document in that the change of a value is described, in particular the change of the packing density of a filter layer with increasing material depth in flow-through direction of this filter layer. A steady change of one of these values means that a value of the packing density with increasing material depth or with advancing movement of an air flow in the flow-through direction through the air filter medium changes with regard to a scalar value only in one direction, for example, increases. Steady means in this context that the value of the packing density increases or rises with increasing material depth. In this context, this value must not increase uniformly and can have across a first depth section a first growth rate and across a second depth section a second growth rate which is either greater or smaller than the first growth rate.

In this context, the term “semi-steady” means that a value, for example, of the packing density, remains constant with increasing material depth across at least one partial depth section of the air filter medium while the packing density changes in only one direction across the remaining material depth.

Steady and semi-steady in any case have the common property that the packing density does not reverse a positive (or negative) growth rate across the material depth. Semi-steady comprises in this context a growth rate of zero while steady means a growth rate of greater than zero.

A constant increase of a value, for example, of the packing density of fibers in a first filter layer, means that a growth rate of the packing density across the entire material depth of the first filter layer remains the same. In other words, the growth rate in this case describes a linear function which has a continuous slope wherein the slope is the growth rate of the packing density.

The specification of the weight per surface area or of the mass per surface area of a filter medium in the case of paper is based on DIN EN ISO 536. In this context, the following deviations can be carried out: Samples are taken at ten different locations of a specimen and tested. The sample size can have a diameter of 56 mm; should the medium to be tested be smaller, then the diameter can also be 42 mm or 25 mm. As a result, the individual values of the samples as well as an average value including mean variation are specified in the unit of measure of g/m².

The specification of the weight per surface area or of the mass per surface area of a filter medium for nonwoven is based on DIN EN ISO 29 073-1. Accordingly, samples at ten different locations of a specimen are to be taken and to be tested. The sample size is at least 50,000 mm² (for example, 250 mm×250 mm), alternatively also 100 cm² are permissible when the medium to be tested is smaller. As a result, the individual values of the samples as well as an average value including mean variation are specified in the unit of measure of g/m².

The determination of the thickness for smooth paper is done according to ISO 534, preferably with deviating surface loading of 1 N/cm². Samples at ten different locations of a specimen are taken and tested. The sample size can have a diameter of 56 mm. In case no flat samples with a diameter in accordance with a diameter of a measuring head of a testing device, for example, 16 mm, are available, strips of the filter medium to be tested can be cut out and measured so that a sample that is in itself of a flat configuration can be measured. As a result, the individual values of the samples as well as an average including mean variation are specified in the unit of measure of mm.

The determination of the thickness for nonwovens is done according to DIN EN ISO 9073-2. Samples at ten different locations of a specimen are taken and tested. The samples can have a size of DIN A5 and are measured at two locations at the surface center. If no samples of this size are available, in deviation therefrom, also smaller samples can be measured. As a result, the individual values of the samples as well as an average value including mean variation are indicated in the unit of measure of mm.

The determination of the thickness for voluminous nonwovens is done according to DIN EN ISO 9073-2. Voluminous nonwovens are nonwovens that upon a change of applied pressure of 0.1 kPa to 0.5 kPa can be compressed by at least 20%, i.e., to 80% of the initial thickness prior to change of the applied pressure. Samples at ten different locations of a specimen are taken and tested. The samples can have a size of 130 mm×80 mm. In case no samples of this size are available, in deviation therefrom, also smaller samples can be measured. As a result, the individual values of the samples as well as an average value including mean variation are specified in the unit of measure of mm.

According to a further embodiment of the invention, the first filter layer comprises a center section that is arranged in the flow-through direction between the first filter layer section and the second filter layer section.

The center section can thus provide an air filter medium of increased thickness or depth of the flow-through direction. With increasing thickness of the air filter medium in the flow-through direction, the dirt particle storage capacity of the air filter medium can be increased.

The first filter layer section and the center section can be designed such that at a transition from the first filter layer section to the center section no packing density jump takes place, i.e., at this transition the packing density of the first filter layer section substantially corresponds to the packing density of the central section.

In analogy, at the transition from the center section to the second filter layer section no packing density jump occurs likewise, or the packing density of the center section at the transition to the second filter layer section is substantially identical to the packing density of the second filter layer section.

According to a further embodiment, the first filter layer comprises an inflow depth section and the first filter layer section is arranged in the flow-through direction downstream of the inflow depth section.

This means that the first filter layer in the flow-through direction first comprises an inflow depth section with increasing packing density which represents the beginning or the inlet surface for the fluid flow to be filtered into the filter medium. The first surface constitutes a surface or a plane (which can also be curved or can have any other geometric course) that is flowed through by the air flow to be filtered.

According to a further embodiment, the inflow depth section is arranged at the first surface of the air filter medium.

This means that the raw air, i.e., the air to be filtered, is supplied to the air filter medium at the first surface of the first filter layer. In other words, in this embodiment, no further filter layer that belongs to the air filter medium is provided upstream of the inflow depth section in the flow-through direction.

According to a further embodiment, the first filter layer has an outflow depth section and the second filter layer section is arranged in the flow-through direction upstream of the outflow depth section.

The outflow depth section constitutes thus at least a portion of the second surface of the first filter layer by means of which the air flow filtered by the first filter layer exits the first filter layer and is supplied to a filtration by the second filter layer, i.e., by the nanofiber filter layer.

In other words, this means that in the first filter layer the first filter layer section, the center section, and the second filter layer section are arranged in flow-through direction between the inflow depth section and the outflow depth section.

Therefore, for determining the packing density or the packing density gradient, the inflow depth section and the outflow depth section in one embodiment must not be taken into account because these two depth sections are properties of the first filter layer which are based on a so-called inlet or outlet roughness of the filter medium material.

According to a further embodiment, the second filter layer is arranged at an outflow surface of the filter medium.

This means that the second filter layer, i.e., the nanofiber filter layer, performs a terminal ultrafine filtration at the outflow side of the filter medium and represents the outflow surface of the filter medium where the filtered fluid exits from the filter medium in the direction of the clean side.

According to a further embodiment, the first filter layer section has a first packing density of fibers and the second filter layer section has a second packing density of fibers, wherein a value of the second packing density is different from a value of the first packing density.

The first filter layer section may comprise in particular more fiber interstices and/or greater fiber interstices than the first filter layer section.

According to a further embodiment, a packing density of fibers of the first filter layer increases from the first filter layer section to the second filter layer section in the flow-through direction. This means, for example, that the fiber interstices in the first filter layer decrease in regard to their number and/or in regard to their size with increasing material depth from the first filter layer section toward the second filter layer section.

That the packing density of the first filter layer section differs from the packing density of the second filter layer section means thus that, within the first filter layer, dirt particles of different size or expansion are filtered out of the air flow and stored in the air filter medium.

According to a further embodiment, the packing density of fibers of the first filter layer increases steadily from the first filter layer section to the second filter layer section in the flow-through direction.

This means that a value of the packing density with increasing material thickness or with increasing movement of an air flow in the flow-through direction through the air filter medium changes with regard to its scalar value only in one direction, in this case increases. Steady means in this context that the value of the packing density with increasing material depth increases or rises. In this context, this value must not increase uniformly.

In one embodiment, the packing density can remain the same, at least section-wise, with increasing material depth in the flow-through direction, which can also be referred to as semi-steady.

According to a further embodiment, a packing density of fibers of the first filter layer in the flow-through direction increases constantly from the first filter layer section to the second filter layer section.

This means that no significant sudden changes of the packing density with increasing material depth will occur. Accordingly, a packing density jump is avoided so that a dirt particle absorption that is limited to a minimal portion of the material depth is prevented in order to enable in this way a complete utilization of the dirt particle storage capacity of the material volume of the air filter medium.

Moreover, a constant increase of the packing density of fibers of the first filter layer means that a growth rate of the packing density across the entire material depth of the first filter layer remains the same. In other words, the growth rate in this case describes a linear function which has a uniform slope, wherein the slope is the growth rate of the packing density.

The packing density at the surface of the air filter medium which is the outflow surface of the clean air is matched to the requirements with regard to purity, i.e., the degree of separation to be achieved.

In one embodiment, the maximum difference of the packing density between filter layer sections that adjoin each other is at most 15%, preferably at most 10%, and further preferred at most 5%.

According to a further embodiment, a value of the second porosity differs from a value of the first porosity.

In analogy to the packing density, this means that the air filter medium or a filter layer can filter dirt particles of different size from the raw air and can store them within the material of the air filter medium.

According to a further embodiment, a porosity of the first filter layer in the flow-through direction decreases from the first filter layer section to the second filter layer section.

According to a further embodiment, a porosity of the first filter layer in the flow-through direction decreases steadily from the first filter layer section to the second filter layer section.

According to further embodiment, a porosity of the first filter layer in the flow-through direction decreases constantly from the first filter layer section to the second filter layer section.

In analogy to the packing density, this means that at the inflow side of an air filter medium, of a filter layer, or of a filter layer section, the coarse dirt particles are absorbed while with increasing material thickness of the air filter medium increasingly finer dirt particles of the raw air are removed and stored in the air filter medium.

The porosity is complementary to the packing density with the proviso that an increasing packing density can be accompanied by a decreasing porosity, for example, in a direction of the air flow from the inflow surface of an air filter medium to its outflow surface.

Accordingly, for the porosity basically the same statements apply that have been made in regard to packing density, wherein in a preferred embodiment the porosity is characterized by a reduction rate in contrast to a growth rate of the packing density. For the change of a value of the porosity, i.e., the reduction rate of the porosity, the statements in regard to steadiness, semi-steadiness, and constancy of the increase of the growth rate of the packing density apply likewise.

A steady and in particular a constant reduction rate of the porosity and thus a prevention of strong and sudden changes of the porosity in the air filter medium can avoid the formation of dirt barriers in the air filter medium. In particular sudden and/or strong porosity changes, i.e., in particular porosity reductions, in an air filter medium can represent a so-called “dirt barrier” where an increased and concentrated accumulation of dirt particles can occur so that the air filter medium may clog or be impaired in regard to its air permeability already for a comparatively small absorption of dirt particles which collect at the aforementioned dirt barrier.

In a preferred embodiment, the porosity within a filter layer decreases constantly. In one embodiment, the porosity at the surfaces of neighboring filter layers can be the same or almost the same. Accordingly, it can be ensured that even between filter layers no dirt barriers are formed because even there no strong and/or sudden increase of the porosity takes place.

In one embodiment, the first filter layer can be integrally manufactured, i.e., the first filter layer is not produced by assembling several layers but is embodied as an individual integrally manufactured filter layer. In particular such an integral manufacture of a filter layer can have the result that the number as well as the dimensions of the packing density jumps or of the porosity jumps can be reduced. A dimension of such a jump refers to the difference between the values of the aforementioned parameter packing density jump and porosity jump in adjoining filter layer sections in the area of the adjoining surfaces.

According to a further embodiment, a first surface of the second filter layer is contacting directly the first filter layer.

The first filter layer and the second filter layer are mechanically coupled to each other or are glued to each other areally across the entire or a part of the surface area of the adjoining surfaces. The first filter layer can be in this context a coarse filtration layer and the second filter layer a fine filtration layer in the form of a nanofiber filter.

According to a further embodiment, a packing density of the second filter layer section is greater than a packing density of the second filter layer.

This means that the packing density, viewed across the filter medium, increases first in the flow-through direction of the first filter layer, while the packing density in the second filter layer drops again in comparison to the first filter layer.

In one embodiment, the second filter layer in the form of a nanofiber layer has smaller pores than at least the second filter layer section of the first filter layer. This variant is distinguished by the advantage that at the transition between first and second filter layers gradually an ultra-small particle layer, for example, carbon particulate layer, forms upon filtration that can grow into the first filter layer. Thanks to the larger pores of the first filter layer, sufficient space exits for the particles. Accordingly, a premature blocking does not occur. As a whole, this leads to an increase of the dirt particle storage capacity.

According to a further embodiment, a porosity of the second filter layer section deviates from a porosity of the second filter layer by at most approximately 15%, preferably at most 10%, and further preferred by at most approximately 5%.

In case that by different manufacturing processes of the first filter layer and of the second filter layer a precise adaptation of the porosity between the second filter layer section and the second filter layer has been realized, it is thus possible to substantially optimally adjust the formation of a dirt barrier or a blocking layer by a defined porosity jump in the indicated range.

According to a further embodiment, the first filter layer section comprises first fibers with a first cross-section and the second filter layer section second fibers with a second cross-section wherein the center section comprises first fibers and second fibers.

The fiber cross-section can be one of several parameters that make it possible to provide a desired packing density or porosity of a filter layer or of a filter layer section. The fiber cross-section can be described in particular by the magnitude of a cross-sectional surface area. For the porosity as well as for the packing density the fiber cross-section alone is not a sufficient descriptive parameter because for these two values precisely the interstices between the employed fibers can be crucial.

In a preferred embodiment, the fibers with a large cross-section are however used for a filter layer section with high porosity and low packing density while the fibers with a small cross-section are employed for a filter layer section with low porosity and high packing density.

Accordingly, with this proviso the first filter layer section has a higher porosity and a lower packing density than the second filter layer section when the first fibers have a greater cross-section than the second fibers.

The center section comprises first fibers as well as second fibers. Accordingly, it is possible to provide a packing density that is increasing or a porosity that is decreasing from the first filter layer section to the second filter layer section.

According to a further embodiment, the first fibers and the second fibers are arranged in the center section in such a way that a proportion of the second fibers in relation to the sum of the first fibers and second fibers in a depth section of the first filter layer increases in the direction of the flow-through direction of the first filter layer.

With the proviso that with the first fibers a low packing density or high porosity and with the second fibers a higher packing density or lower porosity is achieved, an increasing packing density or a decreasing porosity is achieved by means of a proportion of second fibers in the center section that is increasing with increasing material depth in the flow-through direction.

In a first depth section, arranged in the center section at the front in the flow-through direction, the first fibers have a comparatively high and the second fibers a comparatively low proportion in relation to the sum of the fibers in this first depth section while in a second depth section, arranged downstream of the first depth section in the center section in the flow-through direction, the first fibers have a lower proportion and the second fibers a higher proportion in relation to the sum of the fibers in the second depth section in comparison to the first depth section.

This means thus that precisely this arrangement of the first fibers and of the second fibers with the corresponding cross-sections can also affect the provision of the packing density or porosity in the center section.

According to a further embodiment, the first fibers and the second fibers are arranged in the center section such that a proportion of the second fibers in relation to the sum of the first fibers and second fibers increases steadily in a depth section of the first filter layer in the direction of the flow-through direction of the first filter layer.

According to a further embodiment, the first fibers and the second fibers in the center section are arranged such that a proportion of the second fibers in relation to the sum of the first fibers and second fibers increases constantly in a depth section of the first filter layer in the direction of the flow-through direction of the first filter layer.

In regard to the steady and constant increase of the number of second fibers in relation to the sum of the first fibers and second fibers in a depth section, reference is being had basically to the explanations of the steady and constant increase or decrease of the packing density or porosity; these explanations apply likewise in regard to the arrangement of the first and second fibers with their respective cross-sections deviating from each other.

According to a further embodiment, a packing density of the center section increases in the direction of the flow-through direction of the first filter layer.

In case that the packing density of the center section is realized by fibers with different cross-section, the aforesaid in regard to the first fibers and second fibers that have an increasing or decreasing proportion in relation to the sum of the first and second fibers in a depth section in the flow-through direction applies in this context.

According to a further embodiment, the second filter layer section is calendered.

When calendering, a mechanical pressure loading on a surface, i.e., in this case on the surface of the second filter layer section, is applied in order to achieve compaction of the fibers. By calendering, the packing density of the second filter layer section is increased and the porosity, in turn, reduced.

According to a further embodiment, the first filter layer section comprises at least a first fiber with a first cross-section and the second filter layer section at least a second fiber with a second cross-section, wherein the second cross-section is smaller than the first cross-section.

In this way, the first fiber as well as the second fiber can be of any geometric shape, e.g., a prism-shaped body with an elliptical or other base shape.

According to a further embodiment, the first filter layer has a material thickness between approximately 0.2 mm to approximately 0.9 mm and preferably between 0.3 mm and 0.7 mm.

The first filter layer can be a graded cellulose carrier.

According to further embodiment, the air filter medium has an air permeability of approximately 100 l/m²s to approximately 1,000 l/m²s at 200 Pa.

According to a further embodiment, the air filter medium has a weight per surface area of approximately 80 g/m² to approximately 200 g/m² after impregnation and hardening.

Impregnation of a filter layer can be done, for example, with phenolic resin, acrylic resin, epoxy resin and can in particular provide a flame-retarding action.

According to a further embodiment of the invention, the first filter layer can be a graded multi-layer cellulose synthetic carrier with a material thickness in the flow-through direction of 0.4 mm to 0.9 mm, an air permeability of 200 l/m²s to 1,000 l/m²s, and a weight per surface area after impregnation and hardening of 100 g/m² to 200 g/m².

According to a further embodiment of the invention, the first filter layer can be a carded nonwoven and a wet-laid nonwoven layer which are needlepunched and glued together. The carded nonwoven can be of a multi-layer configuration and can have a Bico fiber proportion in a filter layer section on a surface of the outflow surface of greater than approximately 5% of the mass of this filter layer section. The fiber fineness can be up to 1.5 denier. In case of hydroentanglement, the fiber fineness can achieve 0.5 to 50 dtex. The material thickness of the first filter layer of this embodiment can be between 1.0 mm and 4.0 mm with an air permeability of 400 l/m²s and 1,500 l/m²s and a weight per surface area between 200 g/m² and 400 g/m².

The thickness of the air filter medium is proportional to the dirt particle storage capacity of the air filter medium in that an increasing thickness also increases the dirt particle storage capacity.

According to a further embodiment, the first filter layer comprises cellulose-based fibers, synthetic fibers such as PET, PBT, PA, Bico fibers, glass fibers or a combination thereof.

In one embodiment, the Bico fiber proportion in the second filter layer section can be greater than approximately 5% of the mass of the second filter layer section.

Bico fibers are a two-component fiber comprised of a high-temperature melting component (fiber core) and a low-temperature melting component (fiber sheath) and are preferably used as fusible fibers in that the Bico fibers are heated to a temperature above the melting point of the low-temperature melting component and below the melting point of the high-temperature melting component so that the low-temperature melting component melts and fuses the fibers to each other during cooling and hardening.

According to a further embodiment, the second fiber layer section, i.e., the fine filter of the first filter layer that adjoins the second filter layer, comprises fibers with a fiber fineness of approximately 0.5 dtex to approximately 50 dtex, preferably from approximately 1 dtex to approximately 15 dtex.

According to a further embodiment, the second filter layer section comprises fibers with fiber fineness of below approximately 2 denier.

According to a further embodiment, the second filter layer comprises a fiber with a fiber diameter between approximately 50 nm and approximately 500 nm and in particular between 100 nm and 300 nm.

According to a further embodiment, the second filter layer is a PA polymer, a PA 6 polymer, a PA 6.10 polymer, or a PA 66 polymer.

According to a further embodiment, the first filter layer and the second filter layer are coupled mechanically with each other by an adhesive, in particular by means of a dispersion adhesive, i.e., are glued to each other.

The adhesive is applied as a bonding agent at 0.5 g/m² to 5.0 g/m², preferably 1 g/m² to 2 g/m². A minimal application quantity can reduce in this context the risk of electrical breakdown during production because a reduced voltage can be used. Also, pore closure can be prevented by means of a reduced application quantity.

The adhesive can be applied by spraying or by rolling.

The dispersion adhesive can be polyurethane, vinyl acetate, ethylene, polyvinyl acetate, butyl diglycol acetate, copolymer, acrylic acid ester, or a combination thereof.

According to a further embodiment, the first filter layer section comprises a fiber with a fiber diameter between approximately 15 μm and approximately 40 μm.

According to a further embodiment of the invention, the second filter layer section has a fiber with a fiber diameter between approximately 8 μm and approximately 14 μm.

According to further embodiment, the air filter medium comprises a third filter layer wherein the third filter layer in flow-through direction is arranged upstream of the first filter layer.

The third filter layer thus carries out a pre-filtration.

According to a further embodiment, the third filter layer comprises a spunbond layer or a meltblown layer.

According to a further embodiment, the third filter layer is arranged by a cross-laying method on the first filter layer.

According to a further embodiment, the first filter layer comprises a spunbond layer or a meltblown layer.

According to a further embodiment, the first filter layer is a carded nonwoven.

Carding is a method for producing a nonwoven by means of which the lose fibers become oriented.

According to a further embodiment, the air filter medium comprises a fourth filter layer, wherein the fourth filter layer in flow-through direction is arranged upstream of the third filter layer and wherein the fourth filter layer is connected mechanically by needlepunching with the third filter layer and/or the third filter layer is connected mechanically by needlepunching with the first filter layer.

According to a further embodiment, the first filter layer and/or the second filter layer and/or the third filter layer and/or the fourth filter layer are thermally strengthened by thermal bonding.

According to a further embodiment, at least a surface of the first filter layer and/or of the third filter layer and/or of the fourth filter layer is calendered.

Calendering enables adaptation of the packing density of the calendered filter layer.

According to a further embodiment, the calendered surface of the first filter layer and/or of the third filter layer and/or of the fourth filter layer in the flow-through direction is arranged on a rear side of the respective filter layer.

This means that the calendered surface is facing the clean side and comprises a higher packing density as well as that a reduced porosity is provided in order not to surpass a required particle contents at the clean side.

Accordingly, the fiber diameter or the fiber fineness of the fibers of the fourth filter layer is greater than the fiber diameter or the fiber fineness of the fibers of the third filter layer. Accordingly, these fibers can be arranged across the fourth filter layer and the third filter layer arranged downstream thereof in such a way that an increasing packing density and a decreasing porosity across the entire air filter medium are achieved.

These fibers can be arranged in particular such that the fibers with a higher fiber fineness have a higher proportion in relation to the sum of the fibers in a depth section closer to the clean air side than in a depth section father away from the clean air side, as has been described supra in detail.

According to a further embodiment, the first filter layer comprises fibers with a fiber fineness between approximately 1.5 denier and approximately 2 denier or with a fiber diameter between approximately 12 μm and approximately 14 μm.

According to a further embodiment, at least one of the first filter layer, of the second filter layer, of the third filter layer, or of the fourth filter layer comprises fusible fibers with a proportion of approximately 5% to approximately 50% of the mass of the respective filter layer.

The fusible fibers can be, for example, a co-polyester with a melting point between 110° C. and 120° C. which, at the appropriate temperature, are caused to melt in order to effect in this way a strengthening of the other fibers relative to each other. The other fibers can have, for example, a melting point between 220° C. and 250° so that they do not melt at the meting temperature of the fusible fibers.

According to a further embodiment the air filter medium is embodied as a folded filter.

A folded filter medium has a plurality of folds in order to enlarge the surface area of the air filter medium while the size is reduced so that also the service life of an air filter element is extended because a greater filter surface area or a greater dirt particle storage capacity can accommodate more dirt particles before the pressure loss at the filter medium caused by the deposited dust has increased such that an increased power for sucking in air through the air filter medium is required.

In this context, the air filter medium can be folded with all filter layers.

According to a further embodiment, the air filter medium is embodied as a folded filter with variable fold depth.

The air filter medium can be preferably arranged in a housing wherein the housing, due to external space requirements, may be shaped in a predetermined way. Also, in the housing a functional component, for example, in the form of an additional filter element, can be arranged.

Moreover, the constructive configuration of the housing can be matched to outer conditions, for example, the space conditions in a motor compartment of a vehicle. The constructive configuration of the housing has an immediate effect on the size and the shape of the air filter medium and thus also on the filter performance of the air filter medium.

Accordingly, the air filter medium can be, for example, an element with variable fold depth in order to adapt the outer shape of the air filter medium to the constructive requirements in a housing.

The filter layers, as described above and in the following, can be embodied of several filter layer sections that are connected to each other mechanically, for example, by means of needlepunching or hydroentanglement, thermally or chemically, for example, with an adhesive, in particular by means of spray-on adhesive, in particular with PU, or by impregnation.

The layer manufacture can be done by wet-laying or dry-laying, for example, as a carded nonwoven, or in the form of spun nonwoven of filament, in particular by means of spunbonding or by means of meltblowing.

The first filter layer and/or the air filter medium, as described above and in the following, can have a packing density gradient and/or a fiber diameter gradient.

In one embodiment, the air filter medium has a so-called spunbond nanofiber construction with the nanofiber layer at the outflow side of the air filter medium.

In this context, the air filter medium can comprise one or several synthetic filter layers which are combined with each other. At least one of these synthetic filter layers can be produced in accordance with the spunbond manufacturing process. A further layer is comprised of nanofibers.

In order to prevent or reduce the formation of so-called blocking layers or dirt barriers, the air filter medium comprises a packing density gradient in such formation of the so-called blocking layers or dirt barriers is substantially prevented.

By combining a spunbond filter layer with a nanofiber filter layer, the formation of blocking layers can be reduced in that the porosity or packing density of the filter layers, arranged in the flow-through direction upstream of the nanofiber filter, are adjusted in the direction of the nanofiber filters such that at the adjoining surfaces of the first filter layer and of the nanofiber filter layer a substantially identical porosity or packing density is present or in that a predetermined value is not surpassed by the difference of the corresponding parameters of these layers.

By means of this combination, a gradient structure in the air filter medium is generated which, in regard to dust storage capacity and degree of separation of dirt particles, can provide advantages. The aforementioned gradient structure begins at the inflow side with an open porous material and becomes more and more dense and less porous in the flow-through direction. Also, the fiber diameters can decrease from the inflow side to the outflow side. In this context, the spunbond layer can be used as a coarse filtration layer and mainly as a dust storage layer. The nanofiber layer that is arranged at the outflow side can serve as an ultrafine filtration layer and can be used in order to fulfill a required degree of separation of the dirt particles.

As already explained, the gradient structure can also be generated within the spunbond layer in that, for example, a one-sided compaction or smoothing of the fibers is carried out. This can be done, for example, by needlepunching, by thermal bonding, by hydroentanglement, and/or by calendering.

Moreover, it is also conceivable to combine several spunbond layers with each other so that the gradient structure can be formed even more exactly and in particular no porosity or density jumps from one layer to the next are generated in that the porosities or packing densities of adjoining surfaces of neighboring spunbond layers are identical or almost identical. This means that, beginning at the inflow side, first a relatively open fiber layer with fibers with large diameter is arranged, followed by a denser fiber layer with fibers with reduced diameter than the preceding layer. Accordingly, for example, S-S-NF (two spunbond layers followed by one nanofiber layer) or S-S-S-NF (three spunbond layers followed by a nanofiber layer) combinations can be generated. These spunbond layers can be individually produced and subsequently can be connected to each other in a subsequent working step, for example, by needlepunching, by thermal bonding, by hydroentanglement, and/or by calendering.

Alternatively, a single integral spunbond layer can be produced in a single working process in that two or more spray bars are arranged behind each other. They then generate first fibers with large diameters and then increasingly finer ones, or vice versa.

In one embodiment, the air filter medium comprises a so-called spunbond meltblown nanofiber configuration with the nanofiber layer at the outflow side of the air filter medium.

The spunbond layer is produced in accordance with the spunbond manufacturing process, a second layer according to the meltblown process, and a third layer is comprised of nanofibers. For the packing density of adjoining surfaces of the different layers, the aforesaid applies in analogy, i.e., these values are almost identical in order to prevent or reduce the formation of dirt barriers.

In this context, the spunbond layer is used as a coarse filtration layer and mainly as a dust storage layer. The nanofiber layer arranged downstream at the outflow side serves as an ultrafine filtration layer and is used in order to fulfill the corresponding degree of separation. In between, in order to realize a homogenous gradient structure, a meltblown layer is arranged.

An arrangement of the three layers is thus the combination S-M-NF, a spunbond layer followed by a meltblown layer, further followed by a nanofiber layer, each in the direction from the inflow side to the outflow side in the direction of the flow-through direction.

Also, structures as follows can be constructed: S-S-M-NF (two sequentially arranged spunbond layers, followed by a meltblown layer and by a nanofiber layer) or S-S-S-M-NF (three sequentially arranged spunbond layers followed by a meltblown layer and a nanofiber layer).

In one embodiment, a gradient filter medium together with a nanofiber layer is used in a so-called X-NF configuration with the nanofiber layer at the outflow side.

The X layer can also be the combinations of several filter layers, for example, carded nonwoven with carded nonwoven or carded nonwoven with wet-laid nonwoven. These combinations may comprise a gradient structure concerning their porosity or their packing density, as described above and in the following, in that they are very open-pored at the inflow side and comprise at the outflow side a compacted structure.

It is however also conceivable to employ nonwovens that comprise in the compacted structure split fiber proportions in order to achieve an increased degree of separation of the dirt particles from the raw air. In this embodiment, a combination of open-pore and compacted structure with a nanofiber filter layer is thus realized. By means of this combination, an additional refinement of the gradient structure can be created in the filter medium which may generate advantages in relation to the dust storage capacity and degree of separation of the dirt particles from the raw air. This gradient structure begins at the inflow side with an open porous material and becomes more and more dense and less porous in the flow-through direction. Also, the fiber diameters can decrease from the inflow side to the outflow side. In this context, the nonwoven layer at the inflow side is used as a coarse filtration layer and mainly as a dust storage layer. The nanofiber layer arranged at the outflow side serves as an ultrafine filtration layer and is used in order to fulfill a predetermined degree of separation. The nonwoven layer arranged at the inflow side can be comprised of carded nonwoven, wet-laid nonwoven, or combinations of these nonwoven layers.

The gradient structure moreover can also be generated within the nonwoven layer at the inflow side in that a one-sided compaction of the fibers or smoothing of the layer and strengthening is achieved by suitable methods. This can be done, for example, by needlepunching, by thermal bonding, by hydroentanglement, by binding agents (chemical finish), and/or by calendering.

In one embodiment, the nonwoven layer at the inflow side and the nanofiber layer can be generated in one working step.

According to a further aspect, a filter element with a filter medium as described above and in the following is provided.

According to one embodiment, the second filter layer in this context is arranged at the outflow surface of the filter element.

According to a further aspect, an air filter with an air filter medium as described above and in the following is provided.

The air filter can be in particular an air filter for filtration of intake air for an internal combustion engine.

According to aspect 1, a filter medium, particularly an air filter medium, comprises a first filter layer and a second filter layer, wherein the first filter layer comprises a first filter layer section and a second filter layer section that, in a flow-through direction of the filter medium, is arranged downstream of the first filter layer section, wherein the first filter layer section comprises a first packing density of fibers and wherein the second filter layer section comprises a second packing density of fibers which deviates from the first packing density of fibers. In this context, the second filter layer comprises nanofibers and is arranged in the flow-through direction downstream of the first filter layer.

According to aspect 2, a filter medium according to aspect 1 is provided wherein the first filter layer comprises a center section that, in the flow-through direction, is arranged between the first filter layer section and the second filter layer section.

According to aspect 3, a filter medium according to one of the aspects 1 or 2 is provided, wherein the first filter layer comprises an inflow depth section and the first filter layer section is arranged downstream of the inflow depth section in flow-through direction.

According to aspect 4, a filter medium according to one of the preceding aspects is provided wherein the intake depth section is arranged at the first surface of the filter medium.

According to aspect 5, a filter medium according to one of the preceding aspects is provided, wherein the first filter layer comprises an outflow depth section and the second filter layer section is arranged upstream of the outflow depth section in the flow-through direction.

According to aspect 6, a filter medium according to one of the preceding aspects is provided, wherein the second filter layer is arranged at an outflow surface of the filter medium.

According to aspect 7, a filter medium according to one of the preceding aspects is provided, wherein a packing density of fibers of the first filter layer increases in flow-through direction from the first filter layer section to the second filter layer section.

According to aspect 8, a filter medium according to one of the preceding aspects is provided, wherein a packing density of fibers of the first filter layer steadily increases in flow-through direction from the first filter layer section to the second filter layer section.

According to aspect 9, a filter medium according to one of the preceding aspects is provided, wherein a packing density of fibers of the first filter layer constantly increases in flow-through direction from the first filter layer section to the second filter layer section.

According to aspect 10, a filter medium according to one of the preceding aspects is provided, wherein the first filter layer section comprises a first porosity and the second filter layer section a second porosity, wherein a value of the second porosity is smaller than a value of the first porosity.

According to aspect 11, a filter medium according to one of the preceding aspects is provided, wherein a porosity of the first filter layer decreases in flow-through direction from the first filter layer section to the second filter layer section.

According to aspect 12, a filter medium according to one of the preceding aspects is provided, wherein a porosity of the first filter layer decreases steadily in flow-through direction from the first filter layer section to the second filter layer section.

According to aspect 13, a filter medium according to one of the preceding aspects is provided, wherein a porosity of the first filter layer decreases constantly in flow-through direction from the first filter layer section to the second filter layer section.

According to aspect 14, a filter medium according to one of the preceding aspects is provided, wherein a first surface of the second filter layer is contacting directly the first filter layer.

According to aspect 15, a filter medium according to one of the preceding aspects is provided, wherein a packing density of the second filter layer section is greater than a packing density of the second filter layer.

According to aspect 16, a filter medium according to one of the aspects 1 to 14 is provided, wherein a packing density of the second filter layer section deviates from a packing density of the second filter layer by at most approximately 15%, preferably by at most 10%, and further preferred by at most 5%.

According to aspect 17, a filter medium according to one of the preceding aspects is provided, wherein the first filter layer section comprises first fibers with a first cross-section, wherein the second filter layer section comprises second fibers with a second cross-section, wherein the center section comprises first fibers and second fibers.

According to aspect 18, a filter medium according to aspect 17 is provided, wherein the first fibers and the second fibers in the center section are arranged such that a proportion of the second fibers in relation to the sum of the first fibers and second fibers increases in a depth section of the first filter layer in the direction of the flow-through direction of the first filter layer.

According to aspect 19, a filter medium according to one of the aspects 17 or 18 is provided, wherein the first fibers and the second fibers in the center section are arranged such that a proportion of the second fibers in relation to the sum of the first fibers and second fibers increases steadily in a depth section of the first filter layer in the direction of the flow-through direction of the first filter layer.

According to aspect 20, a filter medium according to one of the aspect 17 to 19 is provided, wherein the first fibers and the second fibers in the center section are arranged such that a proportion of the second fibers in relation to the sum of the first fibers and second fibers increases constantly in the depth section of the first filter layer in the direction of the flow-through direction of the first filter layer.

According to aspect 21, a filter medium according to one of the aspects 2 to 20 is provided, wherein a packing density of the center section increases in the direction of the flow-through direction of the first filter layer.

According to aspect 22, a filter medium according to one of the preceding aspects is provided, wherein the second filter layer section is calendered.

According to aspect 23, a filter medium according to one of the preceding aspects is provided, wherein the first filter layer section comprises at least a first fiber with a first cross-section, wherein the second filter layer section comprises at least a second fiber with a second cross-section, wherein the second cross-section is smaller than the first cross-section.

According to aspect 24, a filter medium according to one of the preceding aspects is provided, wherein the first filter layer comprises a material thickness in the direction of the flow-through direction between approximately 0.2 mm to approximately 0.9 mm, preferably 0.3 mm to 0.7 mm.

According to aspect 25, a filter medium according to one of the preceding aspects is provided, wherein the first filter layer comprises an air permeability of approximately 100 l/m²s to approximately 1,000 l/m²s at 200 Pa.

According to aspect 26, a filter medium according to one of the preceding aspects is provided, wherein the first filter layer comprises a weight per surface area of approximately 80 g/m² to approximately 200 g/m².

According to aspect 27, a filter medium according to one of the aspects 1 to 23 is provided, wherein the first filter layer is a graded, multi-layer cellulose synthetic carrier with a material thickness in the flow-through direction of 0.4 mm to 0.9 mm, an air permeability of 200 l/m²s to 1,000 l/m²s, and a weight per surface area after impregnation and hardening of 100 g/m² to 200 g/m².

According to aspect 28, a filter medium according to one of the aspects 1 to 23 is provided, wherein the filter medium has a thickness between approximately 1.0 mm and approximately 4.0 mm.

According to aspect 29, a filter medium according to aspect 28 is provided, wherein the filter medium has an air permeability of approximately 400 l/m²s and approximately 1,500 l/m²s.

According to aspect 30, a filter medium according to one of the aspects 28 or 29 is provided, wherein the filter medium comprises a weight per surface area of approximately 200 g/m² and approximately 400 g/m².

According to aspect 31, a filter medium according to one of the aspects 28 to 30 is provided, wherein the second filter layer section comprises fibers with a fiber fineness of approximately 0.05 dtex to approximately 50 dtex.

According to aspect 32, a filter medium according to one of the aspects 28 to 31 is provided, wherein the second filter layer section comprises fibers with a fiber fineness of below approximately 2 denier.

According to aspect 33, a filter medium according to one of the preceding aspects is provided, wherein the second filter layer comprises a fiber with a fiber diameter between approximately 50 nm and approximately 500 nm, preferably 100 nm to 300 nm.

According to aspect 34, a filter medium according to one of the preceding aspects is provided, wherein the second filter layer comprises a PA polymer, in particular a PA 6, PA 6.10, or PA 66 polymer.

According to aspect 35, a filter medium according to one of the preceding aspects is provided, wherein the first filter layer and the second filter layer are glued to each other by means of an adhesive, in particular by means of a dispersion adhesive.

According to aspect 36, a filter medium according to one of the preceding aspects is provided, wherein the first filter layer section comprises a fiber with a fiber diameter between approximately 12 μm and approximately 40 μm.

According to aspect 37, a filter medium according to one of the preceding aspects is provided, wherein the second filter layer section comprises a fiber with a fiber diameter between approximately 8 μm and approximately 14 μm.

According to aspect 38, a filter medium according to one of the preceding aspects is provided, wherein the first filter layer comprises cellulose-based fibers, synthetic fibers such as PET, PBT, PA, Bico fibers, glass fibers, or a combination thereof.

According to aspect 39, a filter medium according to one of the preceding aspects is provided, further comprising a third filter layer, wherein the third filter layer in flow-through direction is arranged upstream of the first filter layer.

According to aspect 40, a filter medium according to aspect 39 is provided wherein the third filter layer comprises a spunbond layer or a meltblown layer.

According to aspect 41, a filter medium according to one of the aspects 39 or 40 is provided, wherein the third filter layer is arranged by a cross-laying method on the first filter layer.

According to aspect 42, a filter medium according to one of the preceding aspects is provided, further comprising a fourth filter layer (160), wherein the fourth filter layer is arranged upstream of the third filter layer in flow-through direction, wherein the fourth filter layer is connected mechanically by needlepunching with the third filter layer and/or the third filter layer is connected mechanically by needlepunching with the first filter layer.

According to aspect 43, a filter medium according to one of the preceding aspects is provided, wherein the first filter layer and/or the second filter layer and/or the third filter layer and/or the fourth filter layer are thermally strengthened by thermal bonding.

According to aspect 44, a filter medium according to one of the preceding aspects is provided, wherein at least a surface of the first filter layer and/or of the third filter layer and/or of the fourth filter layer is calendered.

According to aspect 45, a filter medium according to one of the preceding aspects is provided, wherein the calendered surface of the first filter layer and/or of the third filter layer and/or of the fourth filter layer is arranged on a rear side of the respective filter layer in the flow-through direction.

According to aspect 46, a filter medium according to one of the preceding claims is provided, wherein at least one of the first filter layer, of the second filter layer, of the third filter layer or of the fourth filter layer comprises melt fibers with a proportion of approximately 5% to approximately 50% of a mass of the respective filter layer.

According to aspect 47, a filter medium according to one of the preceding aspects is provided, wherein the first filter layer comprises a spunbond layer or a meltblown layer.

According to aspect 48, a filter medium according to one of the preceding aspects is provided, wherein the first filter layer is a carded nonwoven.

According to aspect 49, a filter medium according to one of the preceding aspects is provided, wherein the filter medium is configured as a folded filter. According to aspect 50, a filter medium according to aspect 49 is provided wherein the filter medium is embodied as a folded filter with variable fold depth.

According to aspect 51, a filter element, in particular an air filter element, is provided. The filter element comprises a filter medium according to one of the aspects 1 to 50, wherein the filter medium is a folded filter medium.

According to aspect 52, a filter element according to aspect 51 is provided, wherein the second filter layer is arranged at the outflow surface of the filter medium of the filter element.

According to aspect 53, a filter, particularly an air filter, with a filter element according to one of the aspects 51 or 52 is provided.

In the following, with reference to the drawings, embodiments of the invention will be described.

### BRIEF DESCRIPTION OF THE DRAWINGS

FIG. 1 shows a schematic illustration of an air filter medium according to one embodiment.

FIG. 2 shows a schematic illustration of fibers of an air filter medium according to a further embodiment.

FIG. 3 shows a schematic illustration of an air filter medium according to a further embodiment.

FIG. 4A shows a schematic illustration of an air filter medium according to a further embodiment.

FIG. 4B shows a schematic illustration of an air filter medium according to a further embodiment.

FIG. 5 shows a schematic illustration of an air filter medium according to a further embodiment.

FIG. 6A shows a schematic illustration of a cut section of an air filter medium according to a further embodiment.

FIG. 6B shows a schematic illustration of a cut section image of an air filter medium according to a further embodiment.

FIG. 6C shows a schematic illustration of a cut section of an air filter medium according to a further embodiment.

FIG. 7 shows a schematic illustration of the packing density course of a first filter layer of an air filter medium according to a further embodiment.

FIG. 8 shows a schematic illustration of the packing density course of a first filter layer of an air filter medium according to a further embodiment.

### DESCRIPTION OF PREFERRED EMBODIMENTS

The illustrations in the Figures are schematic and not to scale. When same reference numbers are used, they concern the same or similar elements.

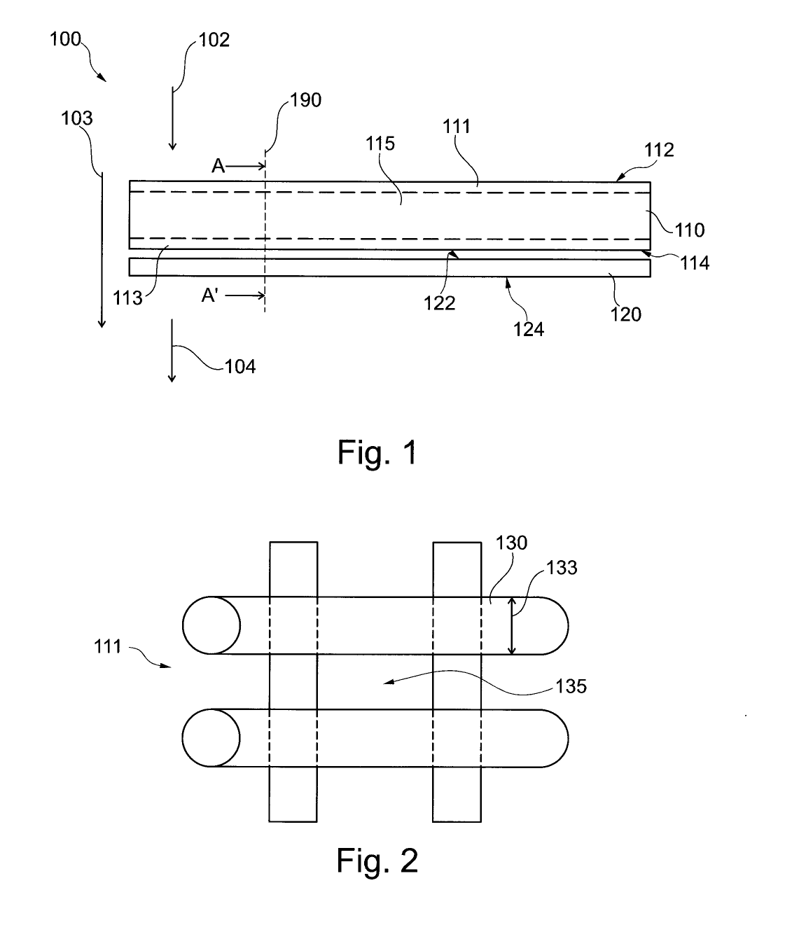

FIG. 1 shows an air filter medium 100 with a first filter layer 110 and a second filter layer 120.

The first filter layer 110 comprises a first filter layer section 111, a second filter layer section 113, and a center section 115, wherein the center section 115 in the direction of the flow-through direction 103 is downstream of the first filter layer section 111 and the second filter layer section 113 is downstream of the center section 115.

The sections 111, 115, 113 are components of an integral first filter layer 110, i.e., the first filter layer was prepared in particular in one working step and was not produced of several individual layers so that within the first filter layer porosity jumps or packing density jumps can be substantially prevented. Furthermore, the sections 111, 115, 113 can differ in particular with regard to the parameters packing density as well as packing density course, wherein the packing density course undergoes a change, in particular an increase, in the direction of the flow-through direction 103.

The first filter layer 110 comprises a first surface 112 and a second surface 114. The first surface is embodied as an inflow surface of the air filter medium which is exposed directly to the raw air which is flowing in the direction of the inflow direction 102.

The second surface 114 adjoins the second filter layer 120, namely such that the second surface 114 of the first filter layer 110 contacts directly a first surface 122 of the second filter layer 120, wherein the surface 114 can be in particular glued to the surface 122.

The second filter layer 120 comprises a second surface 124 which represents the outflow surface of the air filter medium, i.e., this surface 124 is facing the clean side of the air filter medium so that the clean air exits from here the air filter medium in the direction of the outflow direction 104.

The air to be filtered flows through the air filter medium 100 transversely or orthogonally to the illustrated filter layers and filter layer sections.

Moreover, in FIG. 1 a section line A-A′ 190 is illustrated which indicates a position of the cut section illustrated in FIGS. 6A, 6B, and 6C.

FIG. 2 shows a schematic illustration of a fiber mesh of the first filter layer section 111. Shown are four overlapping fibers 130 wherein the fibers each have a fiber diameter or a fiber cross-section 133. Due to overlapping or crossing of the fibers, a pore 135 is produced. The pore is flowed through by the air to be purified and dirt particles get caught in the fiber mesh as soon as the dimensions of a dirt particle surpass the dimensions of the pores and/or impact on the fibers and adhere thereto.

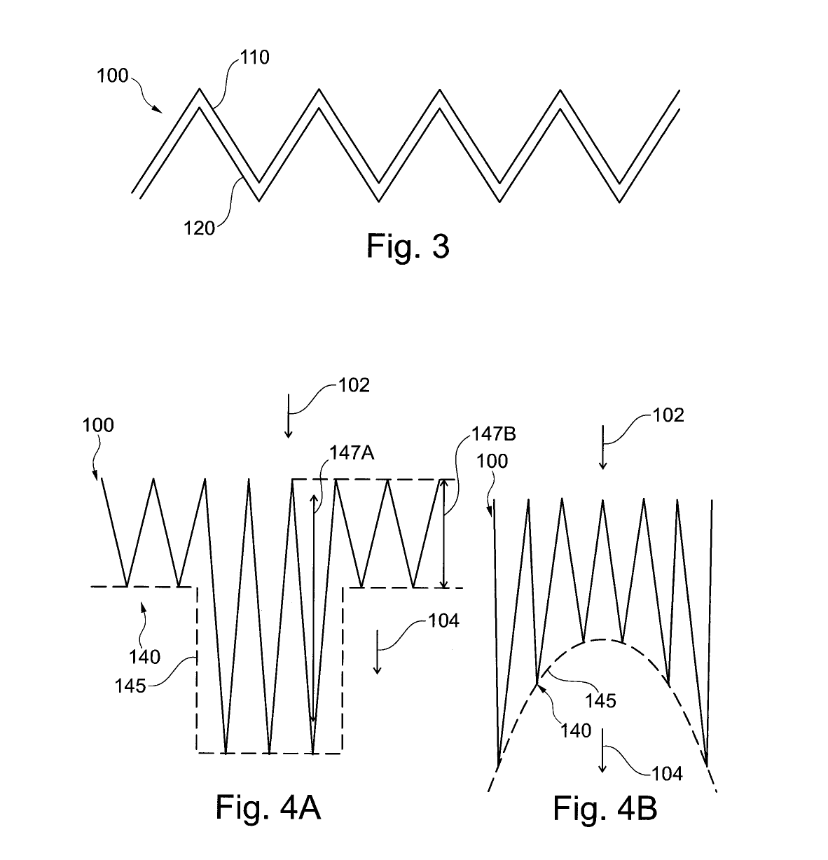

FIG. 3 shows an air filter medium 100 with a first filter layer 110 and a second filter layer 120, wherein the air filter medium 100 is embodied as a folded filter and both filter layers 110, 120 are folded accordingly. The flow-through direction is illustrated with the aid of FIGS. 4A and 4B.

FIG. 4A shows an air filter medium 100 that is embodied as a folded filter with variable fold depth 147. The inflow direction 102 extends in the direction of the fold depth 147. At the outflow side 104 the fold edges 140 of all folds of the air filter medium 100 provide a stepped course 145 with two different filter fold depth areas 147A, 147B wherein the stepped course according to the line 145 can be matched, for example, to a housing shape. The filter fold depth 147B is less than the filter fold depth 147A so that the stepped course of the fold edge line 145 results. The fold edge line 145 can have a linear, slanted, or curved course or can comprise a combination of different shapes.

At the inflow side 102, the fold edges are positioned at the same height. Only for reasons of completeness, it should be noted that also at the inflow side 102 a stepped course or a differently shaped course of the fold edge line is possible.

FIG. 4B shows an air filter medium 100, wherein the fold edge course 145 at the outflow side 104 has an elliptical or parabolic course.

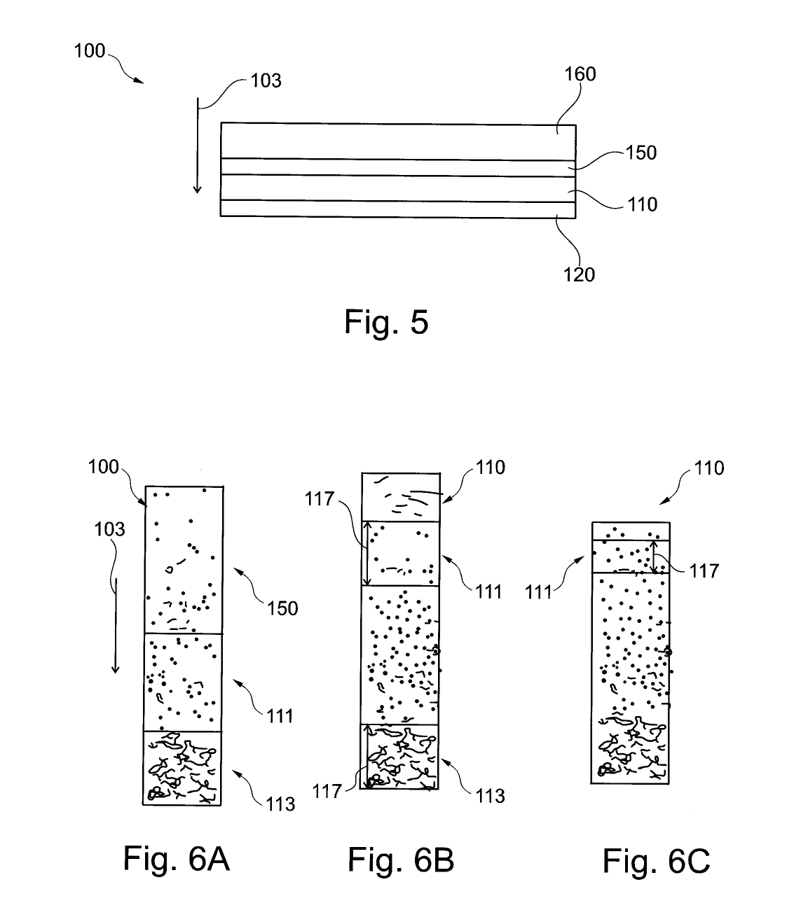

FIG. 5 shows a schematic illustration of an air filter medium 100 with four filter layers, wherein the fourth filter layer 160 is arranged upstream in the flow-through direction 103, the third filter layer 150 immediately downstream of the fourth filter layer 160, the first filter layer 110 immediately downstream of the third filter layer 150, and the second filter layer 120 immediately downstream of the first filter layer 110.

The packing density of the filter fibers in the fourth, third, and first filter layers increases in this context with increasing material depth in the direction of the flow-through direction 103, can then increase even further in the second filter layer 120, embodied as a nanofiber layer, in order to enable absorption of dirt particles across the entire material depth, which can also be referred to as volume storage.

FIG. 6A shows a schematic illustration of a cut section of an air filter medium 100 along the section line A-A′ 190, illustrated in FIG. 1.

The fibers are shown as irregular elements wherein the fiber interstices are shown as white surface between the fibers. It can be seen that the number of fibers with increasing material depth increases in the direction of the flow-through direction 103 and conversely fewer and smaller interstices are observed. Accordingly, the packing density of the fibers increases in the direction of the flow-through direction 103 and the porosity decreases by the same quantity.

In FIG. 6A, the third filter layer 150 and the first filter layer section 111 and the second filter layer section 113 of the first filter layer 110 are illustrated. The number of fibers and the packing density of the fibers increase in the direction 103 from the third filter layer 150 across the first filter layer 110 to the second filter layer 120.

FIG. 6B shows a schematic illustration of a cut section of the first filter layer 110 along the section line A-A′. In the cut section the first filter layer section 111 and the second filter layer section 113 each are illustrated with their filter layer section depth 117, respectively. Only for reasons of completeness, it should be noted that the filter layer sections 111, 113 may have different depths 117 in the direction of the flow-through direction 103.

The filter layer sections 111, 113 can be a depth section of predetermined depth 117 in the direction of the flow-through direction 103 of an integral filter layer.

FIG. 6C shows a schematic illustration of the first filter layer 110 with a first filter layer section 111, wherein its depth 117 deviates from the depth of the first filter layer section of FIG. 6B.

In connection with FIGS. 6A, 6B, and 6C, the evaluation of the packing density of the fibers in a filter layer or in a filter layer section will be explained.

First, a cut of an air filter medium 100 in the direction of the section line 190 is to be carried out. Subsequently, for example, an image of the cut surface can be produced which is subjected to further analysis of the packing density. In the next step, the depth 117 and the position of a filter layer section relative to the material depth in the direction 103 on the cut surface is determined. The air filter medium can be impregnated with a resin which can be made more distinctly visible in an image by a marker. Such a resin is located in this cut section in the interstices but not at locations where, when the cut was performed, a fiber was actually cut through.

The determination of the fiber density can be realized in the image by evaluating the image points on which a fiber can be seen compared to those image points that indicate an interstice. In case of a fixed or known total number of image points in the filter layer section, the packing density can thus be determined in that a ratio is formed of the number of image points that show a filter fiber in relation to the total number of image points in the filter layer section. Alternatively, the number of image points that indicate an interstice can be subtracted from the total number of image points in order to provide a check value in this way, for example. As a function of whether the interstices or the fibers can be distinguished and evaluated better in the cut section, the corresponding image points can be counted.

The thus determined packing density is an average packing density of the evaluated filter layer section. The smaller such a filter layer section is selected, i.e., the smaller the depth 117, the smaller the deviations of the packing density at the edges of the filter layer section from the thus determined average value.

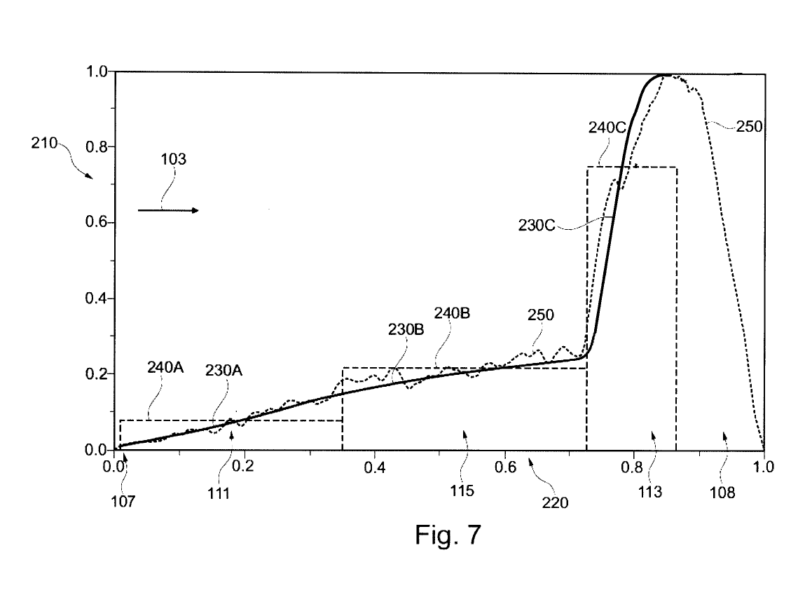

FIG. 7 shows a schematic course of the packing density in the first filter layer wherein the first filter layer is a graded filter layer with synthetic fibers.

The illustration is a standardized illustration with regard to packing density and to the material thickness, i.e., the respective specifications in regard to packing density 210 are in relation to the highest value of the packing density in the first filter layer, wherein the highest value is determined to be 1.0, or to the material thickness of the first filter layer, which is also determined to be 1.0. Concerning the absolute value of the material thickness, reference is being had to the explanations above.

First, it can be seen that the packing density increases in the flow-through direction 103, i.e., beginning at a material depth of 0.0 in the direction of maximum material thickness. In an inflow section 107, which is very small in this embodiment and extends to a standardized material thickness of 0.02 into the material in the flow-through direction, the packing density increases beginning at 0.0.

At the transition into the first filter layer section 111, the packing density further increases and increases within the first filter layer section 111 and within the center section 115. In the second filter layer section 113, a stronger increase of the packing density occurs in comparison to the sections 111, 115 until it passes from the second filter layer section 113 into the outflow section 108 in which the packing density drops.

In each section 111, 115, 113 a smoothed course 230A, 230B, 230C of the packing density and an average packing density 240A, 240B, 240C are indicated wherein the average packing density results from the packing density in each respective filter layer section. The smoothed packing density course can be represented, for example, by means of the sliding window principle in which a certain number of packing density values of adjacently positioned subsections are used for the calculation of the smoothed packing density course. For the next value, in a direction, for example, in the flow-through direction, a new value is added and the value is dropped that was contained as the last one opposite to the flow-through direction.

The packing density course 230A passes at the transition from the first filter layer section 111 to the center section 115 without a jump into the packing density course 230B. The same applies for the transition from the center section 115 to the second filter layer section 113. Independent thereof, the increase of the packing density in the second filter layer section 113 is higher than in the center section or in the first filter layer section.

The slope of the packing density course in the first filter layer section and in the center section can be approximately 1. In the second filter layer section, the slope can be up to approximately 5. These values are determined as a quotient of the slope of the standardized packing density across an increase of the standardized material depth.

The first filter layer section 111 extends indicated in standardized material thickness from approximately 0.02 to approximately 0.35 and has a standardized average packing density of approximately 0.07 to approximately 0.12.

The center section 115 extends from approximately 0.35 to approximately 0.73 of the standardized material thickness and has a standardized average packing density of approximately 0.2 to 0.25. In particular, the standardized average packing density of the center section 115 is greater than the standardized average packing density of the first filter layer section 111 and smaller than the standardized average packing density of the second filter layer section 113.

The second filter layer section extends from approximately 0.73 to approximately 0.85 of the standardized material thickness and has a standardized average packing density of approximately 0.7 to 0.8.

A ratio of the standardized average packing density of the first filter layer section 111 to a standardized average packing density of the second filter layer section 113 of between 0.1 to 0.4 results, in particular between 0.1 to 0.2. A relatively strong gradient is formed.

In addition, in FIG. 7 an exemplary measured course 250 of the packing density is illustrated also. The actual measured course can fluctuate about the smoothed value of the packing density 230A, 230B, 230C, as is indicated in an exemplary fashion by the dotted line 250.

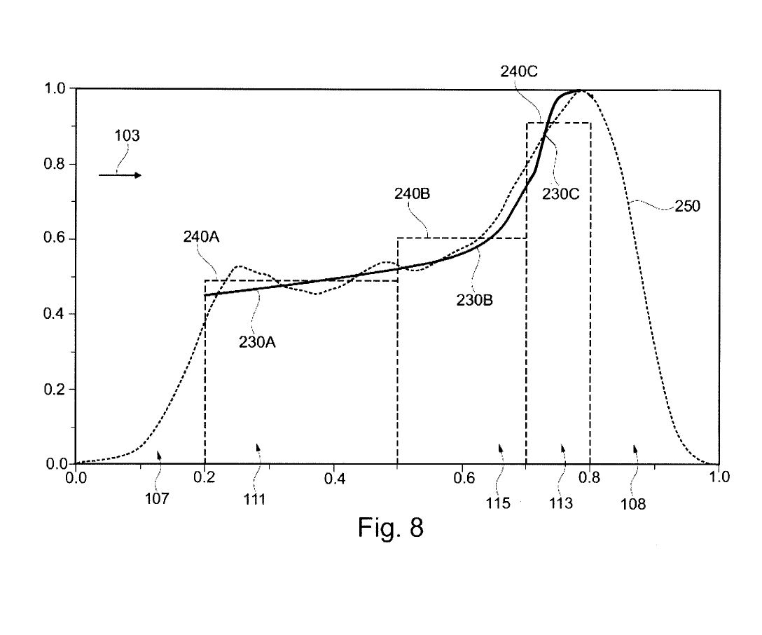

FIG. 8 shows in analogy to FIG. 7 a packing density course of a graded filter layer with cellulose-based fibers, in particular a first filter layer 110 that is comprised at least mostly of cellulose fibers. Concerning FIG. 8, the same general explanations as in connection with FIG. 7 apply with regard to the smoothed packing density course and the average packing density course in the corresponding filter layer sections.

The inflow section 107 can extend across the standardized material thickness up to approximately 0.2.

The first filter layer section 111 extends between approximately 0.2 and 0.5 of the standardized material thickness of the first filter layer. In this section 111, the standardized average packing density amounts to 0.35 to 0.65, especially approximately 0.5, and the smoothed packing density course extends from approximately 0.45 at a material thickness of 0.2 up to approximately 0.52 at a material thickness of 0.5.

The center section 115 extends between approximately 0.5 and 0.7 of the standardized material thickness. The standardized average packing density is 0.5 to 0.7, especially approximately 0.6, and the smoothed packing density course extends from approximately 0.52 at a material thickness of 0.5 to approximately 0.75 at a material thickness of 0.7. In particular, the standardized average packing density of the center section 115 is greater than the standardized average packing density of the first filter layer section 111 and smaller than the standardized average packing density of the second filter layer section 113.

The second filter layer section 113 extends between approximately 0.7 and 0.8 of the standardized material thickness. The standardized average packing density is approximately 0.9 to 0.93 and the smoothed packing density course extends from approximately 0.75 at a material thickness of 0.7 up to 1.0 at a material thickness of approximately 0.8.

A ratio of a standardized average packing density of the first filter layer section 111 to a standardized average packing density of the second filter layer section 113 between 0.25 to 0.65 results, in particular between 0.45 to 0.60. Thanks to this gradient, particularly beneficial conditions result for a cellulose-based filter layer 110.

Subsequently, the value of the packing density drops down to 0.0 in the outflow section 108.

In a further example, not illustrated, the first filter layer 110 comprises at least 50% by weight cellulose fibers and at least 25% by weight synthetic fibers. Beneficial conditions result in this case when the ratio of a standardized average packing density of the first filter layer section 111 to a standardized average packing density of the second filter layer section 113 amounts to between 0.25 to 0.65, preferably between 0.25 to 0.35. In addition, the first filter layer 110, as in the preceding examples, comprises a center section 115 with a standardized average packing density that is greater than the standardized average packing density of the first filter layer section 111 and smaller than the standardized average packing density of the second filter layer section 113.

While specific embodiments of the invention have been shown and described in detail to illustrate the inventive principles, it will be understood that the invention may be embodied otherwise without departing from such principles.

### LIST OF REFERENCE CHARACTERS

100 air filter medium
102 inflow direction
103 flow-through direction
104 outflow direction
107 inflow depth section
108 outflow depth section
110 first filter layer
111 first filter layer section
112 first surface, inflow surface
113 second filter layer section
114 second surface
115 center section
117 depth of a filter layer section
120 second filter layer
122 first surface
124 second surface, outflow surface
130 fiber
133 fiber cross-section
135 pore
140 fold edge
145 course of the fold edges at the outflow side
150 third filter layer
160 fourth filter layer
190 section line A-A′
210 standardized packing density
220 standardized filter layer thickness
230 smoothed packing density course
240 average packing density course
250 measured example of the packing density course

What is claimed is:

1. A filter medium comprising:
a first filter layer;
a second filter layer arranged downstream of the first filter layer in a flow-through direction of the filter medium and comprising a nanofiber;
wherein the first filter layer comprises a first filter layer section and a second filter layer section, wherein the second filter layer section is arranged downstream of the first filter layer section in the flow-through direction of the filter medium;
wherein the first filter layer section comprises a first packing density of fibers;
wherein the second filter layer section comprises a second packing density of fibers that is deviating from the first packing density of fibers.

2. The filter medium according to claim 1, wherein the first filter layer further comprises a center section arranged in the flow-through direction of the filter medium between the first filter layer section and the second filter layer section.

3. The filter medium according to claim 2, wherein a packing density of fibers of the center section increases in the flow-through direction of the first filter layer.

4. The filter medium according to claim 1, wherein the first filter layer further comprises an inflow depth section and wherein the first filter layer section is arranged downstream of the inflow depth section in the flow-through direction of the filter medium.

5. The filter medium according to claim 4, wherein the inflow depth section is arranged at a first surface of the filter medium.

6. The filter medium according to claim 1, wherein the first filter layer further comprises an outflow depth section and wherein the second filter layer section is arranged upstream of the outflow depth section in the flow-through direction of the filter medium.

7. The filter medium according to claim 1, wherein the second filter layer is arranged at an outflow surface of the filter medium.

8. The filter medium according to claim 1, wherein the first packing density of fibers of the first filter layer increases in the flow-through direction of the filter medium from the first filter layer section to the second filter layer section.

9. The filter medium according to claim 1, wherein the second filter layer has a third packing density of fibers and wherein the second packing density of fibers of the second filter layer section is greater than the third packing density of fibers of the second filter layer.

10. The filter medium according to claim 1, wherein the first filter layer section comprises first fibers with a first cross-section, wherein the second filter layer section comprises second fibers with a second cross-section, and wherein the center section comprises the first fibers and the second fibers.

11. The filter medium according to claim 10, wherein the first fibers and the second fibers are arranged in the center section such that a proportion of the second fibers in relation to a sum of the first fibers and the second fibers increases in a depth section of the first filter layer in the flow-through direction of the filter medium.

12. The filter medium according to claim 1, wherein the nanofiber of the second filter layer comprises a fiber diameter between 50 nm and 500 nm.

13. The filter medium according to claim 12, wherein the fiber diameter is 100 nm to 300 nm.

14. The filter medium according to claim 1, wherein the first packing density of fibers of the first filter layer section is a standardized first average packing density and wherein the second packing density of fibers of the second filter layer section is a standardized second average packing density.

15. The filter medium according to claim 14, wherein a ratio of the standardized first average packing density to the standardized second average packing density amounts to between 0.1 to 0.4.

16. The filter medium according to claim 15, wherein the first filter layer further comprises a center section with a standardized third average packing density that is greater than the standardized first average packing density of the first filter layer section and smaller than the standardized second average packing density of the second filter layer section.

17. The filter medium according to claim 16, wherein the first filter layer is embodied at least primarily of synthetic fibers and the ratio is between 0.1 to 0.2.

18. The filter medium according to claim 14, wherein a ratio of the standardized first average packing density to a standardized second average packing density amounts to between 0.25 to 0.65.

19. The filter medium according to claim 18, wherein the first filter layer further comprises a center section with a standardized third average packing density that is greater than the standardized first average packing density of the first filter layer section and smaller than the standardized second average packing density of the second filter layer section.

20. The filter medium according to claim 19, wherein the first filter layer is comprised at least mostly of cellulose fibers and wherein the ratio is between 0.45 to 0.60.

21. The filter medium according to claim 14, wherein a ratio of the standardized first average packing density to the standardized second average packing density amounts to between 0.25 to 0.65.

22. The filter medium according to claim 21, wherein the first filter layer further comprises a center section with a standardized third average packing density that is greater than the standardized first average packing density of the first filter layer section and smaller than the standardized second average packing density of the second filter layer section.

23. The filter medium according to claim 22, wherein the first filter layer comprises at least 50% by weight cellulose fibers and at least 25% by weight synthetic fibers and wherein the ratio is between 0.25 to 0.35.

24. A filter element comprising a filter medium according to claim 1, wherein the filter medium is a folded filter medium, wherein the second filter layer is arranged on an outflow side of the filter element.
